(19) United States
(12) Patent Application Publication
(10) Pub. No.: US 2024/0256901 A1
(43) Pub. Date: Aug. 1, 2024

(54) INFORMATION PROCESSING APPARATUS, INFORMATION PROCESSING METHOD AND NON-TRANSITORY COMPUTER-READABLE STORAGE MEDIUM

(71) Applicant: CANON KABUSHIKI KAISHA, Tokyo (JP)

(72) Inventor: Yoshiki OHNO, Kanagawa (JP)

(21) Appl. No.: 18/408,645

(22) Filed: Jan. 10, 2024

(30) Foreign Application Priority Data
Jan. 30, 2023 (JP) 2023-012128

(51) Int. Cl. G06N 3/0985; G06N 3/0464

(52) U.S. Cl. CPC G06N 3/0985; G06N 3/0464

(57) ABSTRACT

An information processing apparatus comprises one or more memories storing instructions and one or more processors that execute the instructions to acquire, by a process for learning a plurality of tasks, an integration ratio of output of replacement layers for which a shared layer, which is shared by a plurality of tasks in a hierarchical neural network, is replaced by a neural network layer for each task, and acquire a learned parameter of the shared layer based on the acquired integration ratio and learned parameters of the replacement layers acquired by the process for learning.

### BACKGROUND OF THE INVENTION

### Field of the Invention

The present invention relates to a learning technique.

### Description of the Related Art

There are techniques in which a device such as a computer learns contents of data such as images and sounds, and performs recognition. An objective of a recognition process is referred to herein as a recognition task, and a mathematical model for learning and executing a recognition task is referred to as a recognition model.

Recognition tasks include, for example, an object detection task for detecting a specific object (a face, a pupil, a head, an animal, a vehicle, or the like) from an image, and a region detection task for performing object detection on a pixel-by-pixel basis of an image called semantic region division.

In addition, there are various recognition tasks such as an object category recognition task for determining a category (a human, an animal, a vehicle, or the like) of an object (subject) in an image, a tracking task for searching for and tracking a particular subject, and a scene type recognition task for determining a scene type (a city, a mountain area, a coastal area, or the like). Hereinafter, a recognition task is referred to as a task.

Neural networks are known as a technology for learning and executing the above-described tasks. Deep (a large number of layers) multilayered neural networks are also referred to as deep neural networks (DNN). DNN is an abbreviation for Deep Neural Network. In particular, deep convolutional neural networks are referred to as Deep Convolutional Neural Networks (DCNN). DCNN is an abbreviation for Deep Convolutional Neural Network. DCNNs have attracted attention in recent years because of their higher performance (recognition accuracy and recognition performance).

There is a technique called multitask learning, in which a plurality of tasks are learned and executed by one recognition model. For example, Caruana, R. (1997) “Multitask learning, Machine learning” 28 (1), pp. 41 to 75 describes how to learn a plurality of tasks using a single DNN provided with a plurality of output units for a plurality of tasks. In Caruana, R. (1997) “Multitask learning, Machine learning” 28 (1), pp. 41 to 75, a portion of a DNN has shared layers that all tasks use, and the shared layers are learned using data of all of the tasks. Japanese Patent No. 6750854 discloses a method of determining whether or not to make a specific layer be a shared layer in a plurality of multilayered neural networks and thereby reducing network scale.

In a case where tasks are related to each other, performance is improved by the tasks utilizing each other's feature amounts when learning is performed using a shared layer, rather than learning all the layers independently. Further, by sharing layers, the size of the recognition model is reduced, and there is an advantage that the learning is faster and memory usage can be reduced.

However, if there is no relatedness between tasks, the performance of one task may decrease as the performance of another task increases, depending on the combination of tasks. In particular, in a case where the size of the neural network is small, a situation can easily occur where there is a competition for feature amounts between tasks, and there is a trade-off relationship.

In a situation where large-scale computational resources can be used and the size of the neural network can also be increased, this may not cause a problem, but in a case where high-speed processing and low power consumption are required, the size of the neural network needs to be reduced as much as possible, and the above-described problem occurs. In addition, in the case of installation in an embedded device such as a camera or a smartphone, since computational resources are limited, the size of the neural network must be reduced, and the above-described problem is particularly likely to occur.

As described above, in a case where there are hardware restrictions, there is a need to devise techniques for learning where some layers are made to be shared layers to save on resources even in cases where the compatibility of tasks is not good.

For example, when compatibility between tasks and characteristics are known in advance, the balance of learning can be controlled by prioritizing and weighting each task according to compatibility and characteristics at the time of learning. However, in order to determine the desired priorities and weights, trial-and-error repetition of learning and adjustment is necessary, and this is inefficient.

In addition, in many cases, it is rare that the compatibility between tasks is known in advance, and results cannot be predicted until actually learned. In particular, when the number of tasks is large, it is difficult to know the compatibility between all the tasks and characteristics in advance.

As described above, Japanese Patent No. 6750854 discloses a method of determining whether or not to make a specific layer be a shared layer in a plurality of multilayered neural networks and thereby reducing network scale. However, there is no mention of how to learn shared layers better on the assumption that the layers that are to be shared layers are defined in advance. In addition, it is difficult to predict the final network scale in advance, and therefore application in a case where there is a restriction on the network scale is difficult.

### SUMMARY OF THE INVENTION

The present invention provides a technique for, in a hierarchical neural network having a shared layer shared by a plurality of tasks, in a case of learning the plurality of tasks, efficiently and better learning the shared layer even if compatibility between the tasks is unknown.

According to the first aspect of the present invention, there is provided an information processing apparatus comprising one or more memories storing instructions and one or more processors that execute the instructions to: acquire, by a process for learning a plurality of tasks, an integration ratio of output of replacement layers for which a shared layer, which is shared by a plurality of tasks in a hierarchical neural network, is replaced by a neural network layer for each task; and acquire a learned parameter of the shared layer based on the acquired integration ratio and learned parameters of the replacement layers acquired by the process for learning.

According to the second aspect of the present invention, there is provided an information processing apparatus comprising one or more memories storing instructions and one or more processors that execute the instructions to: acquire, by learning processing, an integration ratio for output of a unique layer that is unique to each task in a hierarchical neural network; and acquire a learned parameter of a layer that integrates two or more unique layers based on the acquired integration ratio and a learned parameter of the unique layers.

According to the third aspect of the present invention, there is provided an information processing method performed by an information processing apparatus, the method comprising: acquiring, by a process for learning a plurality of tasks, an integration ratio of output of replacement layers for which a shared layer, which is shared by a plurality of tasks in a hierarchical neural network, is replaced by a neural network layer for each task; and acquiring a learned parameter of the shared layer based on the acquired integration ratio and learned parameters of the replacement layers acquired by the process for learning.

According to the fourth aspect of the present invention, there is provided an information processing method performed by an information processing apparatus, the method comprising: acquiring, by learning processing, an integration ratio for output of a unique layer that is unique to each task in a hierarchical neural network; and acquiring a learned parameter of a layer that integrates two or more unique layers based on the acquired integration ratio and a learned parameter of the unique layers.

According to the fifth aspect of the present invention, there is provided a non-transitory computer-readable storage medium storing a computer program for causing a computer to acquire, by a process for learning a plurality of tasks, an integration ratio of output of replacement layers for which a shared layer, which is shared by a plurality of tasks in a hierarchical neural network, is replaced by a neural network layer for each task; and acquire a learned parameter of the shared layer based on the acquired integration ratio and learned parameters of the replacement layers acquired by the process for learning.

According to the sixth aspect of the present invention, there is provided a non-transitory computer-readable storage medium storing a computer program for causing a computer to acquire, by learning processing, an integration ratio for output of a unique layer that is unique to each task in a hierarchical neural network; and acquire a learned parameter of a layer that integrates two or more unique layers based on the acquired integration ratio and a learned parameter of the unique layers.

Further features of the present invention will become apparent from the following description of exemplary embodiments with reference to the attached drawings.

### BRIEF DESCRIPTION OF THE DRAWINGS

FIG. 1 is a block diagram illustrating an example of a functional configuration of an information processing apparatus 100.

FIG. 2A is a diagram illustrating an exemplary configuration of a hierarchical neural network.

FIG. 2B is a diagram illustrating an exemplary configuration of a hierarchical neural network.

FIG. 3A is a flowchart of a process performed by the information processing apparatus 100 to learn a shared layer group 200.

FIG. 3B is a flowchart of a process performed by the information processing apparatus 100 to learn the shared layer group 200.

FIG. 4 is a diagram illustrating a configuration example of a shared layer group 210.

FIG. 5 is a flowchart of a process performed by the information processing apparatus 100 to learn the shared layer group 200.

FIG. 6 is a diagram illustrating a configuration example of the shared layer group 210.

FIG. 7 is a diagram illustrating a configuration example of a recognition model 270.

FIG. 8 is a flowchart of a process performed by the information processing apparatus 100 to learn the shared layer group 200.

FIG. 9 is a block diagram illustrating an example of a hardware configuration of the information processing apparatus 100.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

The present embodiment describes an example of an information processing apparatus 100 that, in a hierarchical neural network that executes M (M is an integer of 2 or more) types of tasks, acquires, by learning processing in the hierarchical neural network, parameters in replacement layers for which a shared layer shared by a plurality of tasks is replaced by a neural network layer for each task, and acquires parameters in the shared layer based on those acquired parameters. In the present embodiment, a case where M=2 will be described, but the following description applies similarly even if M is an integer equal to or greater than 3.

Here, as the hierarchical neural network, a DCNN or the like can be used. Various types of DCNN configurations may be used. Typically, a DCNN is a neural network that performs tasks by repeating processing of convolutional layers and processing of pooling layers to gradually aggregate local characteristics of input information and to obtain information that is robust against deformation and positional deviation. For example, what is described in A. Krizhevsky et al. “ImageNet Classification with Deep Convolutional Neural Networks”, Proc. Advances in Neural Information Processing Systems 25 (NIPS 2012) or the like can be used.

An example of a hardware configuration of the information processing apparatus 100 according to the present embodiment will be described with reference to a block diagram of FIG. 9. Note that the hardware configuration illustrated in FIG. 9 is only an example of a configuration applicable to the information processing apparatus 100 according to the present embodiment, and can be changed/modified as appropriate.

A processor 901 executes various processes using computer programs and data stored in a memory 902. Thus, the processor 901 controls the overall operation of the information processing apparatus 100 and executes or controls various processes described as processing performed by the information processing apparatus 100.

The memory 902 has an area for storing computer programs and data loaded from a storage apparatus 903, and an area for storing computer programs and data received from the outside via an input interface 904. Further, the memory 902 has a work area used when the processor 901 executes various kinds of processing. As described above, the memory 902 can appropriately provide various areas.

The storage apparatus 903 is a large capacity information storage apparatus such as a hard disk drive apparatus. The storage apparatus 903 stores an OS (operating system), computer programs and data for causing the processor 901 to execute or control various processing described as processing performed by the information processing apparatus 100, and the like. The computer programs and data stored in the storage apparatus 903 are loaded into the memory 902 as appropriate under the control of the processor 901, and are processed by the processor 901. Note that the storage apparatus 903 may be a memory apparatus that is detachable from the information processing apparatus 100 such as a USB, or may be a drive apparatus that reads and writes computer programs and data from and to a recording medium such as a CD-ROM.

A user interface such as a keyboard, a mouse, or a touch panel may be connected to the input interface 904. When the user operates such a user interface, various instructions and information are notified to the processor 901 via the input interface 904.

An output interface 905 may be an interface for connecting devices such as a display apparatus and a print apparatus, or may be a communication interface for connecting to a network such as a LAN or a WAN. The processor 901, the memory 902, the storage apparatus 903, the input interface 904, and the output interface 905 are all connected to a system bus 906.

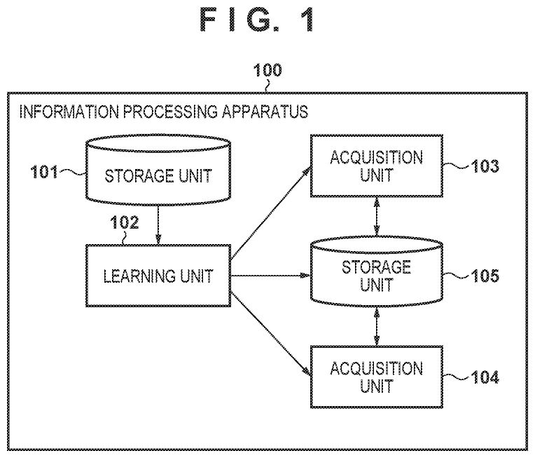

An example of a functional configuration of the information processing apparatus 100 is illustrated in a block diagram of FIG. 1. In the present embodiment, a case in which the functional units (except a storage unit 101 and a storage unit 105) illustrated in FIG. 1 are all implemented by software (computer program) will be described. The storage unit 101 and the storage unit 105 are implemented by the memory 902 and the storage apparatus 903.

In the following description, functional units (excluding the storage unit 101 and the storage unit 105) illustrated in FIG. 1 are sometimes described as main processing units, but in practice, the functions of the functional units are realized by the processor 901 executing a computer program corresponding to the functional unit.

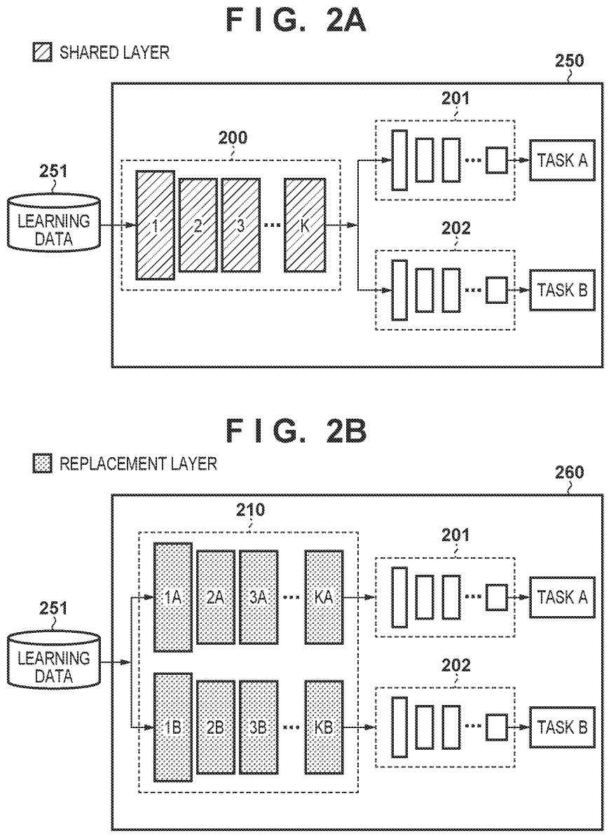

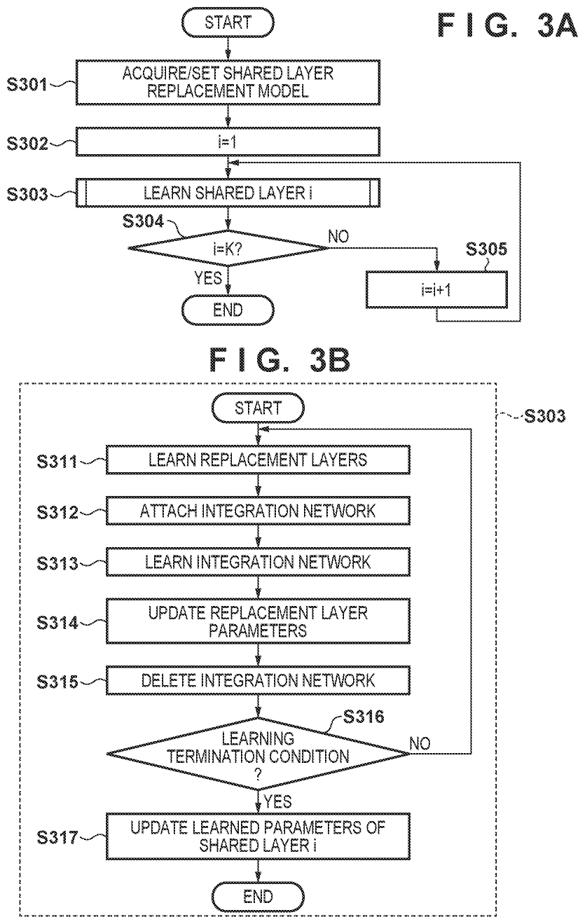

Here, a hierarchical neural network according to the present embodiment will be described. In the present embodiment, it is assumed that the hierarchical neural network is capable of executing two types of tasks, task A and task B. Here, the task A is an object detection task which is a task for detecting a specific object from an input image, and the task B is a region detection task which is a task for detecting a specific region from an input image. As illustrated in FIG. 2A, the hierarchical neural network is a recognition model 250 having a shared layer group 200 shared between the task A and the task B, a layer group 201 unique to the task A used only in the task A, and a layer group 202 unique to the task B used only in the task B. The shared layer group 200 has K (K is an integer of 1 or higher) layers (shared layer 1, shared layer 2, . . . , shared layer K). In a case where the shared layer group 200 is shared by three or more tasks, the shared layer group 200 may be shared by all of the three or more tasks, may be shared by some of the three or more tasks, or both of a shared layer group shared by all of the three or more tasks and a shared layer group shared by some of the three or more tasks may be mixed. In addition, the shared layers may be arranged continuously or interspersed among the other layers. Each of the layer group 201 and the layer group 202 has one or more layers. In a phase in which a task is executed, characteristics of input data are calculated in the shared layer group 200, and then each task-specific operation is performed in the layer group specific to the task. It is thereby possible to reduce the amount of memory used for holding weights (learned parameters) used in each shared layer. In addition, redundant feature calculation is prevented and efficiency is increased.

In the recognition model 250, in a case where the task A is executed, the execution result of the task A is outputted by the operations of the shared layer group 200 and the layer group 201, and in a case where the task B is executed, the execution result of the task B is outputted by the operations of the shared layer group 200 and the layer group 202. Of course, in a case where the task A and the task B are executed substantially simultaneously, the calculation by the shared layer group 200 is performed only once.

Hereinafter, a case in which the learning of the shared layer group 200 is performed using learning data 251 will be described. In the present embodiment, the learning data 251 includes learning data A for learning the task A and learning data B for learning the task B.

The learning data A includes a collection of sets of input images and information on frames (bounding boxes) surrounding objects to be detected in the input images. The learning data B includes a group of sets of input images and map information in which a label is attached to each pixel in the input images.

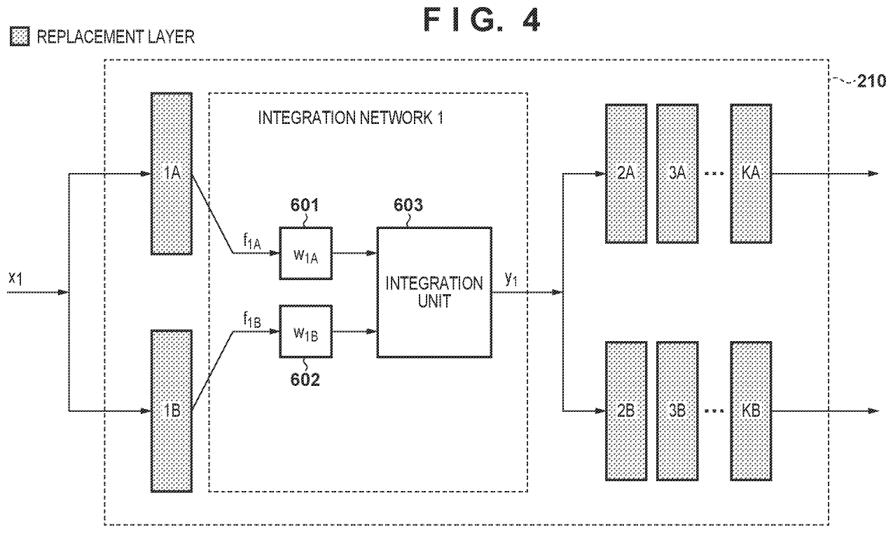

A process performed by the information processing apparatus 100 to learn the shared layer group 200 will be described in accordance with a flowchart in FIG. 3A. In step S301, an acquisition unit 103 acquires a “recognition model 260 having the example configuration illustrated in FIG. 2B”, which is stored in advance in the storage unit 105 as a shared layer replacement model corresponding to the recognition model 250. As illustrated in FIG. 2B, in the configuration of the recognition model 250, the recognition model 260 has a configuration in which the shared layer group 200 is replaced with “a shared layer group 210 in which each shared layer included in the shared layer group 200 is replaced with a layer unique to the task A (replacement layer A) and a layer unique to the task B (replacement layer B)”. The replacement layer A and the replacement layer B corresponding to the shared layer have the same structure (neural network structure) as the shared layer. In the shared layer group 210, replacement layer iA (i=1 to K) is a replacement layer unique to the task A in shared layer i of the shared layer group 200, and replacement layer iB is a replacement layer unique to the task B in the shared layer i of the shared layer group 200.

The acquisition method of the recognition model 260 by the acquisition unit 103 is not limited to a particular acquisition method. For example, the acquisition unit 103 may acquire the recognition model 260 by generating, as the recognition model 260, a model in which each shared layer of the shared layer group 200 is replaced with the replacement layer A and the replacement layer B in the recognition model 250 according to a prescribed replacement method.

Further, in step S301, an acquisition unit 104 sets learned parameters (weight matrices) of the respective shared layers in the shared layer group 200 stored in the storage unit 105 to the replacement layers corresponding to the shared layers. That is, the acquisition unit 104 sets the learned parameters of the shared layer i to the replacement layer iA and the replacement layer iB. In step S302, a learning unit 102 initializes the value of a variable i to 1.

In step S303, a process for learning the shared layer i of the recognition model 250 is performed using the learning data 251 stored in the storage unit 101 and the recognition model 260 in which the learned parameters are set in the respective replacement layers in step S301. Details of the processing in step S303 will be described in accordance with a flowchart of FIG. 3B.

In step S311, in a case where i=1, the learning unit 102 performs a process for learning (a process of updating the learned parameters of a replacement layer jA) the replacement layer jA (j=1 to K) of the recognition model 260 using the learning data A. Further, the learning unit 102 performs a process for learning (a process of updating the learned parameters of a replacement layer jB) the replacement layer jB of the recognition model 260 using the learning data B.

In a case where i>1, the learning unit 102 performs a process for learning the replacement layer of the recognition model 260 (processing for updating the learned parameters of a replacement layer qA (q=i to K)) using the learning data A while keeping the learned parameters of a replacement layer pA (p=1 to (i−1)) of the recognition model 260 fixed. Furthermore, the learning unit 102 performs a process for learning the replacement layer of the recognition model 260 (a process for updating the learned parameters of a replacement layer qB) using the learning data B while keeping the learned parameters of a replacement layer pB of the recognition model 260 fixed.

In step S312, the learning unit 102 inserts an integration network i between the replacement layers i (the replacement layer iA and the replacement layer iB) and the replacement layers (i+1) (the replacement layer (i+1)A and the replacement layer (i+1)B). FIG. 4 shows a configuration example of the shared layer group 210 in a case where an integration network 1 is inserted in the case where i=1.

A weight multiplier 601 multiplies a learned parameter w_{1A} with an output f_{1A} from the replacement layer 1A to which an input xi is inputted. Here, when the number of channels of the output f_{1A} is n, the learned parameter w_{1A} is a matrix of [w1A1, w1A2, . . . , w1A1, w1An]. Further, “multiplying the output f_{1A} by the learned parameter w1A” is an operation in which a matrix of a channel 1 of the output f_{1A} is multiplied by w1A1, the matrix of a channel 2 of the output f_{1A} is multiplied by w1A2, and so on. Thus, the dimensions of the output f_{1A} and the dimensions of the result of multiplying the output f_{1A} and the learned parameter w_{1A} match.

A weight multiplier 602 multiplies a learned parameter w_{1B} with an output f_{1B} from the replacement layer 1B to which the input xi is inputted. The weight multiplication unit 601 and the weight multiplication unit 602 may be implemented as a 1×1 convolution layer that performs convolution only in the spatial direction and does not perform convolution in the channel direction.

An integration unit 603 obtains an integration result y₁ obtained by integrating the multiplication result obtained by the weight multiplication unit 601 and the multiplication result obtained by the weight multiplication unit 602. The dimensions of the integration result y₁ match the dimensions of the result of multiplication by the weight multiplication unit 601 and the dimensions of the result of multiplication by the weight multiplication unit 602. For example, if the integration unit 603 is implemented as a simple adder, the integration network will be a linear adder with respect to the input.

In step S313, the learning unit 102, until the learned parameters of the replacement layer pA (p=1 to i) are fixed, performs a process for learning the replacement layer of the recognition model 260 and the integration network i inserted in step S312 by using the learning data A (processing for updating the learned parameters of the replacement layer qA (q=(i+1) to K) and the integration network i). Also, the learning unit 102, until the learned parameters of the replacement layer pB (p=1 to i) are fixed, performs a process for learning the replacement layer of the recognition model 260 and the integration network i inserted in step S312 by using the learning data B (processing for updating the learned parameters of the replacement layer qB (q=(i+1) to K) and the integration network i inserted in step S312). The learning by the learning unit 102 in step S313 is performed such that the learning of both tasks A and B2 is performed so as to proceed in parallel (rather than independently and sequentially). The learning proceeding means that, for example, the value of a loss function decreases in the learning. Through such a learning process, the learned parameters w_{iA} and w_{iB} are learned (updated). The learned parameters w_{iA} and w_{iB} are also parameters for determining a ratio (integration ratio) at which the output of the replacement layer iA and the output of the replacement layer iB are integrated.

For example, it is known that, when the task A and the task B are related tasks, higher learning performance can be achieved by the two sharing information with each other rather than independently learning each task. In such a case, the learning parameters w_{iA} and w_{iB} in the example of FIG. 4 are learned so as to converge to a value that further improves the learning performance obtained in step S311.

On the contrary, it is known that, when the task A and the task B are unrelated tasks, learning performance may suffer due to the two sharing information with each other rather than independently learning each task. In such a case, the learning parameters w_{1A} and w_{1B} in the example of FIG. 4 are learned so as to converge to a value with which the learning performance obtained in step S311 does not suffer, as much as possible.

In the case of FIG. 4, the learning parameters w_{1A} and w_{1B} obtained by the learning can be interpreted as contributions to the learning of the task A and task B in the shared layer 1. For example, in a case where the learning parameters w1A and w_{1B} after the learning are such that w_{1A}>>w_{1B}, it indicates that the output f_{1A} of the replacement layer 1A is not only useful for the learning of the task A but also useful for the learning of the task B. It is difficult to manually determine a good integration ratio between the respective tasks in advance, and adjustment thereof is more difficult as the number of tasks M increases. In the present embodiment, since the integration ratio can be dynamically determined, the learning efficiency can be improved.

In step S314, the acquisition unit 104 obtains learned parameters of the replacement layer iA and the replacement layer iB such that the output of the replacement layer iA and the replacement layer iB becomes equivalent to the output of the integration network even if the integration network is deleted.

For example, in a case where i=1, assuming that each of the replacement layer 1A and the replacement layer 1B are convolution layers and the integration unit 603 is an adder, in FIG. 4, an output y₁ of the integration network 1 is expressed by the following Equation 1.

$${y}_{1} = ( {x}_{1} * {c}_{1 A} * {w}_{1 A} ) + ( {x}_{1} * {c}_{1 B} * {w}_{1 B} ) \qquad ( 1 )$$

Here, c1A and c1B are learned parameters of the replacement layer 1A and the replacement layer 1B, respectively. Since each convolution layer is linear, Equation 1 is expressed as indicated in Equation 2 below.

$${y}_{1} = {x}_{1} * ( {c}_{1 A} * {w}_{1 A} + {c}_{1 B} * {w}_{1 B} ) \qquad ( 2 )$$

That is, the output of the replacement layer 1A and the replacement layer 1B becomes equivalent to the output of the integration network 1 even if the integration network 1 is deleted, if c1A′ indicated in the following (Equation 3) is set as the learned parameters of the replacement layer 1A and c1B′ indicated in the following (Equation 3) is set as the learned parameters of the replacement layer 1B.

$${c}_{1 {A}^{′}} = {c}_{1 {B}^{′}} = {c}_{1 A} * {w}_{1 A} + {c}_{1 B} * {w}_{1 B} \qquad ( 3 )$$

In step S315, the learning unit 102 deletes the integration network i inserted in step S312. As a result, the configuration of the recognition model 260 is the configuration illustrated in FIG. 2B. However, by the process of step S314, the output of the replacement layer iA and the replacement layer iB in FIG. 2B are equivalent to the output of the integration network i. In addition, the learned parameters of the replacement layer iA and the learned parameters of the replacement layer iB are the same.

In step S316, the learning unit 102 determines whether or not a termination condition for the learning of the shared layer i is satisfied. The termination condition is not limited to a specific condition. For example, the termination condition may be “the number of times that the processing of step S311 to step S315 is repeated is equal to or more than the threshold value” or may be “the value of a loss function in the learning is equal to or less than the threshold value”. In a case where the result of the determination is that the termination condition is satisfied, the process proceeds to step S317, and in a case where the termination condition is not satisfied, the process proceeds to step S311. In step S317, the acquisition unit 104 updates the learned parameters of the shared layer i in the recognition model 250 to the learned parameters of the replacement layer iA or the replacement layer iB.

In step S304, the learning unit 102 determines whether or not the value of the variable i matches K (the learning of all the shared layers is completed). In a case where the result of this determination is that the value of the variable i matches K (the learning of all the shared layers has been completed), the process according to the flowchart in FIG. 3A ends. On the other hand, if the value of the variable i does not match K (there remains a shared layer for which learning has not been completed), the process proceeds to step S305. In step S305, the learning unit 102 increments the value of a variable i to 1.

Here, the knowledge obtained by the learning of previous shared layers may be utilized for the learning of subsequent shared layers. For example, the values of the learning parameters w_{iA} and w_{1B} obtained by the learning of the shared layer 1, that is, the integration ratio may be useful for the learning of the shared layer 2. Therefore, when an integration network 2 is learned in the shared layer 2, initial parameters of learning parameters w_{2A} and w₂B in the integration network 2 are set to the learning parameters w_{iA} and w_{iB}, whereby the learning can be optimized.

Further, the processing of step S301 and step S303 may be repeated a plurality of times. As described above, according to the present embodiment, since the integration ratio is learned to configure the shared layer, it is possible to improve the learning efficiency of the shared layer.

### Second Embodiment

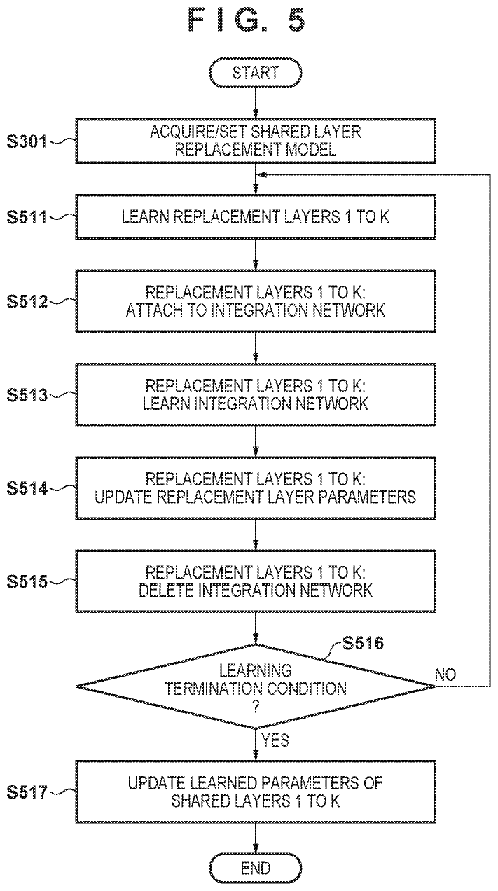

In the following embodiments including the present embodiment, differences from the first embodiment will be described; the embodiments are assumed to be similar to the first embodiment unless otherwise particularly mentioned below. A process performed by the information processing apparatus 100 to learn the shared layer group 200 will be described in accordance with a flowchart in FIG. 5. In FIG. 5, the same processing steps as the processing steps illustrated in FIGS. 3A and 3B are denoted by the same step numbers, and the explanation of these processing steps is omitted.

In step S511, the learning unit 102 performs a process for learning (a process of updating the learned parameters of a replacement layer jA) the replacement layer jA (=1 to K) of the recognition model 260 using the learning data A. Further, the learning unit 102 performs a process for learning (a process of updating the learned parameters of a replacement layer jB) the replacement layer jB of the recognition model 260 using the learning data B.

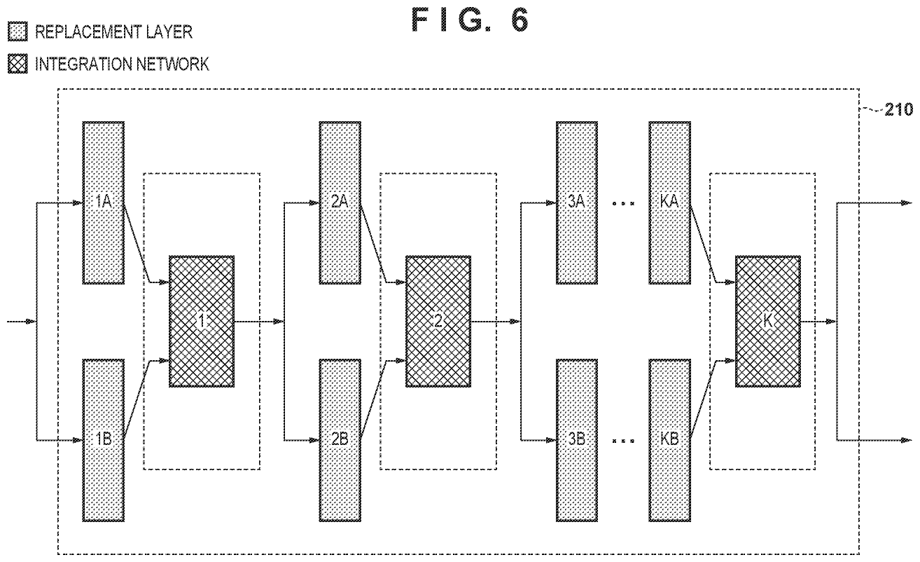

In step S512, the learning unit 102 inserts the integration network i between the replacement layers i (the replacement layer iA and the replacement layer iB) and the replacement layers (i+1) (the replacement layer (i+1)A and the replacement layer (i+1)B) for i=1 to (K−1), as illustrated in FIG. 6. As illustrated in FIG. 6, the learning unit 102 inserts an integration network K that inputs the output of the replacement layer K (the replacement layer KA and a replacement layer KB).

In step S513, the learning unit 102 performs the processing of step S313 on the replacement layer i (i=1 to K) to obtain a learned parameter (integration ratio) of the integration network i.

In step S514, the acquisition unit 104 performs processing similar to step S314 on the replacement layer i (i=1 to K) to obtain learned parameters of the replacement layer iA and the replacement layer iB. In step S515, the learning unit 102 deletes each of the integration networks inserted in step S512.

In step S516, the learning unit 102 determines whether or not a learning termination condition is satisfied. The termination condition is not limited to a specific condition. In a case where the result of the determination is that the termination condition is satisfied, the process proceeds to step S517, and in a case where the termination condition is not satisfied, the process proceeds to step S511.

In step S517, the acquisition unit 104 updates the learned parameters of the replacement layer i (i=1 to K) in the recognition model 250 to the learned parameters of the replacement layer iA or the replacement layer iB.

In the first embodiment, the replacement layers are learned in order from the previous stage. Therefore, even if the learning performance deteriorates due to replacement layers in the previous stage, there is a possibility that the deterioration can be recovered at the time of learning of replacement layers in the subsequent stage. However, in a case where sufficient learning performance is achieved even when the learning of all the replacement layers is performed all together, the second embodiment can perform more efficient learning than the first embodiment.

### Third Embodiment

In the first and second embodiments, regarding the replacement layer i in the shared layer replacement model, there are M (the number of tasks) replacement layers that replace the shared layer i in the recognition model 250. Regarding the replacement layer i in the shared layer replacement model according to the present embodiment, there are N (N>M) replacement layers that replace the shared layer i in the recognition model 250. Processing performed by the information processing apparatus 100 to learn the shared layer group 200 will be described in accordance with a flowchart in FIG. 3A.

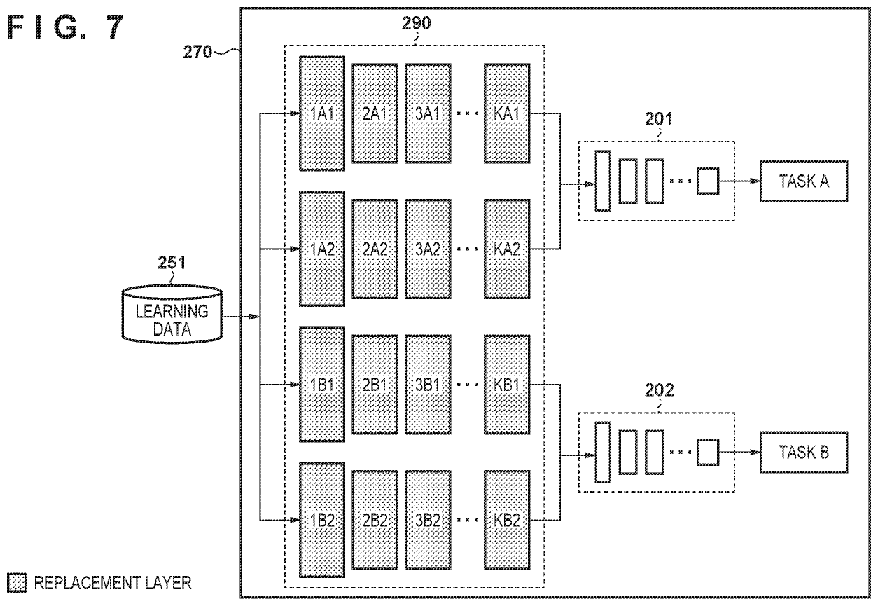

In step S301, the acquisition unit 103 acquires a “recognition model 270 having the example configuration illustrated in FIG. 7” which is stored in advance in the storage unit 105 as the shared layer replacement model corresponding to the recognition model 250. In the configuration of the recognition model 250, the recognition model 270 has a configuration in which the shared layer group 200 is replaced with “a shared layer group 290 in which each shared layer included in the shared layer group 200 is replaced with layers unique to the task A (a replacement layer A1 and a replacement layer A2) and layers unique to the task B (a replacement layer B1 and a replacement layer B2)”.

In the shared layer group 290, a replacement layer iA1 (i=1 to K) is a replacement layer specific to a subtask A1 (a task in which the bounding box detects an object larger than a predetermined size) included in the task A in the shared layer i of the shared layer group 200. A replacement layer iA2 (i=1 to K) is a replacement layer specific to a subtask A2 (a task in which the bounding box detects an object smaller than a predetermined size) included in the task A in the shared layer i of the shared layer group 200. A replacement layer iB1 is a replacement layer specific to a subtask B1 included in the task B in the shared layer i of the shared layer group 200, and a replacement layer iB2 is a replacement layer specific to a subtask B2 included in the task B in the shared layer i of the shared layer group 200.

In step S311, in a case where i=1, the learning unit 102 performs the learning process (processing for updating the learned parameters of a replacement layer jA1) of the replacement layer jA1 (j=1 to K) of the recognition model 270 using learning data A1 (the learning data for learning the subtask A1). Further, the learning unit 102 performs learning processing (processing for updating learned parameters of a replacement layer jA2) of the replacement layer jA2 (j=1 to K) of the recognition model 270 using learning data A2 (learning data for learning the subtask A2). Further, the learning unit 102 performs learning processing (processing for updating learned parameters of a replacement layer jB1) of the replacement layer jB1 (j=1 to K) of the recognition model 270 using learning data B1 (learning data for learning the subtask B1). Further, the learning unit 102 performs learning processing (processing for updating learned parameters of a replacement layer jB2) of the replacement layer jB2 (j=1 to K) of the recognition model 270 using learning data B2 (learning data for learning the subtask B2).

In a case where i>1, the learning unit 102 performs a process for learning a replacement layer of the recognition model 270 (processing for updating the learned parameters of the replacement layer qA1 (q=i to K)) using the learning data A1 while keeping the learned parameters of the replacement layer pA1 (p=1 to (i−1)) of the recognition model 270 fixed. Furthermore, the learning unit 102 performs a process for learning a replacement layer of the recognition model 270 (a process for updating the learned parameters of a replacement layer qA2) using learning data A2 while keeping the learned parameters of a replacement layer pA2 of the recognition model 270 fixed. Furthermore, the learning unit 102 performs a process for learning a replacement layer of the recognition model 270 (a process for updating the learned parameters of a replacement layer qB1) using learning data B1 while keeping the learned parameters of a replacement layer pB1 of the recognition model 270 fixed. Furthermore, the learning unit 102 performs a process for learning the replacement layer of the recognition model 270 (a process for updating the learned parameters of a replacement layer qB2) using the learning data B2 while keeping the learned parameters of a replacement layer pB2 of the recognition model 270 fixed. All the learning data A1, A2, B1, and B2 are included in the learning data 251.

When both of an object larger than a predetermined size and an object smaller than the predetermined size are learned in the same layer, there is the possibility of convergence to a model specialized for any size unless a learning image appearance ratio and a loss function application method are devised. However, by performing learning by dividing replacement layers into those for objects larger than a predetermined size and those for objects smaller than the predetermined size, replacement layers specialized for each size of object can be created, and so by integrating them appropriately, it is possible to learn a recognition model that combines both characteristics.

In step S312, the learning unit 102 inserts the integration network i between replacement layers i (the replacement layer iA1, the replacement layer iA2, the replacement layer iB1, the replacement layer iB2) and replacement layers (i+1) (a replacement layer (i+1) A1, a replacement layer (i+1) A2, a replacement layer (i+1) B1, and a replacement layer (i+1) B2). As in the first embodiment, this integration network i integrates the result of multiplying the respective outputs from the replacement layers i and the learned parameters.

In step S313, the learning unit 102, until the learned parameters of the replacement layer p (p=1 to i) are fixed, performs a process for learning the replacement layers of the recognition model 260 and the integration network i inserted in step S312 by using the learning data A1, A2, B1, and B2 (processing for updating the learned parameters of the replacement layer qA1, qA2, qB1, and qB2 and the integration network i). Here, q=(i+1) to K. Note that the learning unit 102 learns the replacement layer qA1 using the learning data A1, learns the replacement layer qA2 using the learning data A2, learns the replacement layer qB1 using learning data B1, and learns replacement layer qB2 using the learning data B2.

In step S314, similarly to the first embodiment, the acquisition unit 104 obtains learned parameters of the replacement layer i such that the output of the replacement layer i becomes equivalent to the output of the integration network i even if the integration network i is deleted. Then, the acquisition unit 104 sets the learned parameters of the replacement layer i as the learned parameters of the replacement layer i.

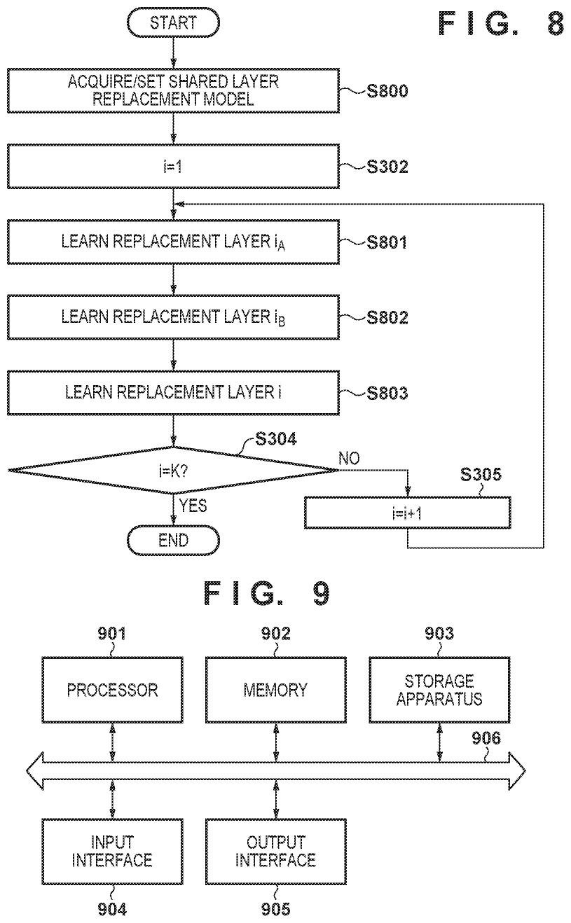

In the present embodiment, the shared layer group 200 can be learned in accordance with the flowchart of FIG. 8. In FIG. 8, the same processing steps as the processing steps illustrated in FIGS. 3A and 3B are denoted by the same step numbers, and the explanation of these processing steps is omitted.

In step S800, the acquisition unit 103 acquires the recognition model 270 stored in advance in the storage unit 105 as a shared layer replacement model corresponding to the recognition model 250. In step S801, the replacement layer iA of the recognition model 260 is learned by performing the processing of step S303 using the replacement layer iA1 and the replacement layer iA2 instead of the replacement layer iA and the replacement layer iB according to the first embodiment.

In step S802, the replacement layer iB of the recognition model 260 is learned by performing the processing of step S303 using the replacement layer iB1 and the replacement layer iB2 instead of the replacement layer iA and the replacement layer iB according to the first embodiment.

In step S803, instead of the replacement layer iA and the replacement layer iB according to the first embodiment, the replacement layer iA learned in step S801 and the replacement layer iB learned in step S802 are used to perform the process of step S303, whereby the replacement layer i is learned.

Further, in the present embodiment, the processing according to the flowchart of FIG. 5 is also applicable. An example in which replacement layers are divided by a bounding box size is given as an example in which a variation is imparted to the learned parameters, but the present invention is not limited thereto. For example, a method of applying data augmentation at the time of learning may be changed, and the replacement layers may be divided by brightness or rotation angle in the learning data to be learned. In this case, it is possible to create replacement layers specialized for each type of data augmentation, and to integrate them appropriately.

Further, the learning data to be used may be the same in each replacement layer, and hyperparameters to be used for learning may be set to different values in each replacement layer to be learned. For example, an optimization algorithm for updating learned parameters includes a hyperparameter such as a learning rate, and the hyperparameter is set to a different value for each replacement layer to be learned. When the replacement layers are integrated, a replacement layer learned by a good hyperparameter is integrated so as to have a high integration ratio, and a replacement layer learned by an unsuitable hyperparameter is integrated so as to have a low integration ratio or so as to be ignored. Also, if there are a plurality of replacement layers learned with good hyperparameters, the integration ratio is learned so as to integrate them with the best possible combination. In general, it is difficult to manually adjust hyperparameters to an optimum value, and therefore trial and error is required, but by using the present embodiment, it is possible to automatically select a good hyperparameter. In addition, by checking the integration ratio at the time of integration, it is possible to know, after learning, which hyperparameter among the hyperparameters used for learning is a good setting value.

In addition, a plurality of replacement layers may be learned by making learning conditions such as learning data and hyperparameters the same. In this case, a plurality of replacement layers learned under the same condition are created. By integrating the replacement layers well, it is possible to create a more robust model for the learning condition than when perform learning using one type of layer.

As described above, according to the present embodiment, replacement layers are also constructed for the sub-tasks included in the task. As a result, variation of the learned parameters of each task that the integration is based on increases, and therefore better shared layers can be generated at the time of the integration.

### Fourth Embodiment

A case in which the recognition model 250 illustrated in FIG. 2A is not applied, and the recognition model 260 illustrated in FIG. 2B is applied is assumed. Since the number of layers of the recognition model 260 is larger than the number of layers of the recognition model 250, various costs such as the amount of learned parameters of the recognition model 260, the amount of information of the recognition model 260, the learning time, and the time required for the recognition process need to be larger than those of the recognition model 250. According to the above-described embodiments, since the learned parameters of the shared layers in the recognition model 250 are obtained from the recognition model 260, it is possible to obtain a recognition model 250 with a lower cost than the recognition model 260 as a result.

In such a case, the information processing apparatus 100 acquires, in a hierarchical neural network, an integration ratio of output of unique layers that are unique to each task by a learning process, and acquires learned parameters of a layer in which two or more unique layers are integrated based on the integration ratio and the learned parameters of the unique layers. As a result, a recognition model 250 comprising that layer (learned parameters have already been acquired) as a shared layer is obtained.

Further, the numerical values, processing timings, processing orders, the performers of the processing, acquisition methods/transmission destinations/transmission sources/storage locations of data (information), and the like used in the above-described embodiments are given as examples for the purpose of concrete explanation, and the invention is not intended to be limited to such examples.

In addition, some or all of the above-described embodiments may be appropriately combined and used. In addition, some or all of the above-described embodiments may be selectively used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-012128, filed Jan. 30, 2023, which is hereby incorporated by reference herein in its entirety.

What is claimed is:

1. An information processing apparatus comprising one or more memories storing instructions and one or more processors that execute the instructions to:
acquire, by a process for learning a plurality of tasks, an integration ratio of output of replacement layers for which a shared layer, which is shared by a plurality of tasks in a hierarchical neural network, is replaced by a neural network layer for each task; and
acquire a learned parameter of the shared layer based on the acquired integration ratio and learned parameters of the replacement layers acquired by the process for learning.

2. The information processing apparatus according to claim 1, wherein the one or more processors execute the instructions to acquire, as a shared layer replacement model, a hierarchical neural network in which a shared layer in the hierarchical neural network is replaced by replacement layers for each task, and acquire, as the integration ratio, a weight that is updated by performing a process for learning the hierarchical neural network, which is made to contain an integration network in which products of output from each replacement layer corresponding to the shared layer in the shared layer replacement model and the weight are integrated and output.

3. The information processing apparatus according to claim 2, wherein the one or more processors execute the instructions to acquire the learned parameter of the shared layer such that output from the replacement layers is equivalent to output of the integration network.

4. The information processing apparatus according to claim 1, wherein, in a case where the integration ratio of output of the replacement layers is acquired, the one or more processors execute the instructions to acquire the learned parameter of the shared layer based on the integration ratio.

5. The information processing apparatus according to claim 1, wherein, in a case where an integration ratio of output of the replacement layers corresponding to a respective shared layer is acquired, the one or more processors execute the instructions to acquire the learned parameter of that shared layer based on that integration ratio and the learned parameters of the replacement layers.

6. The information processing apparatus according to claim 1, wherein the task is a plurality of sub-tasks corresponding to one task.

7. The information processing apparatus according to claim 1, wherein the replacement layer comprises a neural network structure that is the same as the shared layer.

8. An information processing apparatus comprising one or more memories storing instructions and one or more processors that execute the instructions to:
acquire, by learning processing, an integration ratio for output of a unique layer that is unique to each task in a hierarchical neural network; and
acquire a learned parameter of a layer that integrates two or more unique layers based on the acquired integration ratio and a learned parameter of the unique layers.

9. An information processing method performed by an information processing apparatus, the method comprising:
acquiring, by a process for learning a plurality of tasks, an integration ratio of output of replacement layers for which a shared layer, which is shared by a plurality of tasks in a hierarchical neural network, is replaced by a neural network layer for each task; and
acquiring a learned parameter of the shared layer based on the acquired integration ratio and learned parameters of the replacement layers acquired by the process for learning.

10. An information processing method performed by an information processing apparatus, the method comprising:
acquiring, by learning processing, an integration ratio for output of a unique layer that is unique to each task in a hierarchical neural network; and
acquiring a learned parameter of a layer that integrates two or more unique layers based on the acquired integration ratio and a learned parameter of the unique layers.

11. A non-transitory computer-readable storage medium storing a computer program for causing a computer to
acquire, by a process for learning a plurality of tasks, an integration ratio of output of replacement layers for which a shared layer, which is shared by a plurality of tasks in a hierarchical neural network, is replaced by a neural network layer for each task; and
acquire a learned parameter of the shared layer based on the acquired integration ratio and learned parameters of the replacement layers acquired by the process for learning.

12. A non-transitory computer-readable storage medium storing a computer program for causing a computer to
acquire, by learning processing, an integration ratio for output of a unique layer that is unique to each task in a hierarchical neural network; and
acquire a learned parameter of a layer that integrates two or more unique layers based on the acquired integration ratio and a learned parameter of the unique layers.
